(19) United States
(12) Patent Application Publication
(10) Pub. No.: US 2011/0074746 A1
(43) Pub. Date: Mar. 31, 2011

(54) DRIVING CIRCUIT FOR DISPLAY DEVICE AND METHOD FOR DRIVING THE SAME

(76) Inventors: Kuk-Hui Chang, Gyeonggi-do (KR); Young-Nam Lee, Gyeonggi-do (KR)

(21) Appl. No.: 12/893,484

(22) Filed: Sep. 29, 2010

(30) Foreign Application Priority Data
Sep. 29, 2009 (KR) 10-2009-0092432

(51) Int. Cl. G06F 3/038

(52) U.S. Cl. 345/204

(57) ABSTRACT

A driving circuit for a display device comprises a plurality of data driving units supplying image data to a display portion of a panel through data link lines formed at a non-display portion of the panel; and a driving controller sequentially generating a plurality of source output enable signals determining output timing of the image data from the data driving units, and directly supplying each of the source output enable signals to each of the data driving units to sequentially drive the data driving units.

This application claims the benefit of the Korean Patent Application No. 10-2009-0092432, filed on Sep. 29, 2009, which is hereby incorporated by reference as if fully set forth herein.

### BACKGROUND OF THE INVENTION

1. Field of the Invention

The present invention relates to a driving circuit for a display device and a method for driving the same, and more particularly, to a driving circuit for a display device and a method for driving the same, in which a plurality of source output enable signals are generated and directly supplied to their corresponding data driving units to prevent distortion deviation between image data of each data driving unit, which is caused by distortion deviation of the source output enable signals, from occurring.

2. Discussion of the Related Art

A driving integrated circuit includes a plurality of data driving units for supplying image data to data lines within a panel. The data driving units are sequentially output in accordance with source output enable signals output from a driving controller. To this end, the source output enable signals are sequentially delayed by a signal delaying portion and sequentially supplied to the data driving unit. However, a problem occurs in that distortion deviation occurs between image data of the data driving unit initially driven by the source output enable signals and image data of the data driving unit finally driven by the source output enable signals supplied through a plurality of signal delay portions. For this reason, a problem occurs in that high luminance difference between pixels at the center of a display portion and pixels at both ends of the display portion occurs, whereby picture quality is deteriorated.

### SUMMARY OF THE INVENTION

Accordingly, the present invention is directed to a driving circuit for a display device and a method for driving the same, which substantially obviate one or more problems due to limitations and disadvantages of the related art.

An object of the present invention is to provide a driving circuit for a display device and a method for driving the same, in which a driving controller generates a plurality of source output enable signals sequentially output using an external control signal and directly supplies each of the source output enable signals to a corresponding data driving unit, thereby preventing distortion deviation between image data of each data driving unit, which is caused by distortion deviation of the source output enable signals, from occurring.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a driving circuit for a display device according to the present invention comprises a plurality of data driving units supplying image data to a display portion of a panel through data link lines formed at a non-display portion of the panel; and a driving controller sequentially generating a plurality of source output enable signals determining output timing of the image data from the data driving units, and directly supplying each of the source output enable signals to each of the data driving units to sequentially drive the data driving units.

n number of data driving units (n is an even number greater than 3) are arranged at both sides of the driving controller based on the driving controller in half as much as n/2, and the driving controller sequentially supplies n/2 number of source output enable signals to n/2 number of data driving units arranged at one side of the driving controller, so that the data driving unit located closest to the driving controller to the data driving unit located farthest away from the driving controller are sequentially driven, and also sequentially supplies n/2 number of another source output enable signals to n/2 number of data driving units arranged at the other side of the driving controller, so that the data driving unit located closest to the driving controller to the data driving unit located farthest away from the driving controller are sequentially driven.

The data driving controller includes a data alignment unit realigning image data from an external system and outputting them; a sample/holding unit sequentially sampling and holding the image data from the data alignment unit; and a control signal generator receiving a control signal from the external system and outputting various timing control signals including the source output enable signals.

Each data driving unit includes a latch unit supplied with m/n number of sampled image data among m number of sampled image data (m=k*n; k is a natural number greater than 3) from the sample/holding unit, and outputting m/n number of sampled image data at the same time in response to the source output enable signals from the control signal generator; a digital-to-analog converter converting the m/n number of sampled image data from the latch unit to analog signals; and a signal buffer buffering the image data from the digital-to-analog converter.

The control signal generator includes a plurality of signal generators generating n/2 number of source output enable signals in response to a control signal from the external system.

n number of data driving units (n is an even number greater than 3) are arranged at both sides of the driving controller based on the driving controller in half as much as n/2, and the driving controller sequentially supplies n/2 number of source output enable signals to n/2 number of data driving units arranged at one side of the driving controller, so that the data driving unit located closest to the driving controller to the data driving unit located farthest away from the driving controller are sequentially driven, and also sequentially supplies n/2 number of another source output enable signals to n/2 number of data driving units arranged at the other side of the driving controller, so that the data driving unit located farthest away from the driving controller to the data driving unit located closest to the driving controller are sequentially driven.

In another aspect of the present invention, a method for driving a driving circuit for a display device including a plurality of data driving units supplying image data to a display portion of a panel through data link lines formed at a non-display portion of the panel comprises sequentially generating a plurality of source output enable signals determining output timing of the image data from the data driving units; and directly supplying each of the source output enable signals to each of the data driving units to sequentially drive the data driving units.

The source output enable signals are output from a driving controller, n number of data driving units (n is an even number greater than 3) are arranged at both sides of the driving controller based on the driving controller in half as much as n/2, and the driving controller sequentially supplies n/2 number of source output enable signals to n/2 number of data driving units arranged at one side of the driving controller, so that the data driving unit located closest to the driving controller to the data driving unit located farthest away from the driving controller are sequentially driven, and also sequentially supplies n/2 number of another source output enable signals to n/2 number of data driving units arranged at the other side of the driving controller, so that the data driving unit located closest to the driving controller to the data driving unit located farthest away from the driving controller are sequentially driven.

The source output enable signals are output from a driving controller, n number of data driving units (n is an even number greater than 3) are arranged at both sides of the driving controller based on the driving controller in half as much as n/2, and the driving controller sequentially supplies n/2 number of source output enable signals to n/2 number of data driving units arranged at one side of the driving controller, so that the data driving unit located closest to the driving controller to the data driving unit located farthest away from the driving controller are sequentially driven, and also sequentially supplies n/2 number of another source output enable signals to n/2 number of data driving units arranged at the other side of the driving controller, so that the data driving unit located farthest away from the driving controller to the data driving unit located closest to the driving controller are sequentially driven.

The driving circuit for a display device and the method for driving the same according to the present invention have the following advantages.

As the driving controller generates a plurality of source output enable signals sequentially output using an external control signal and directly supplies each of the source output enable signals to a corresponding data driving unit, distortion deviation between image data of each data driving unit, which is caused by distortion deviation of the source output enable signals, can be prevented from occurring. Accordingly, high luminance difference between pixels at the center of a display portion and pixels at both ends of the display portion occurs can be prevented from occurring, whereby picture quality can be improved.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram illustrating a driving circuit for a display device according to one embodiment of the present invention;

FIG. 2 is a detailed diagram illustrating a driving circuit of FIG. 1;

FIG. 3 is a detailed schematic diagram illustrating a driving integrated circuit according to the first embodiment of the present invention;

FIG. 4 is a detailed diagram illustrating a driving controller and a data driving unit of FIG. 3;

FIG. 5 is a detailed schematic diagram illustrating a driving controller; and

FIG. 6 is a detailed schematic diagram illustrating a driving integrated circuit according to the second embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

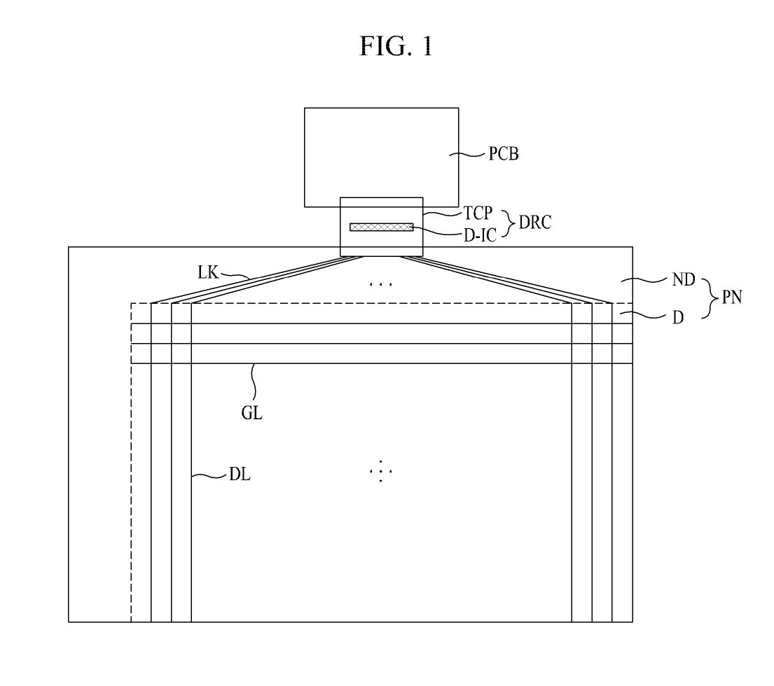

FIG. 1 is a diagram illustrating a driving circuit for a display device according to one embodiment of the present invention.

A display device shown in FIG. 1 includes a panel PN and a driving circuit DRC, wherein the panel includes a display portion D for displaying image and a non-display portion ND surrounding the display portion D, and the driving circuit DRC includes a driving integrated circuit D-IC generating various signals required to display image in the display portion D of the panel PN and a surface-mounted tape carrier package (TCP) packaged with the driving integrated circuit (D-IC).

An example of the surface-mounted tape carrier package includes a tape carrier package.

One side of the driving circuit DRC is connected to a printed circuit board PCB, and the other side of the driving circuit DRC is connected to the non-display portion ND of the panel PN. Examples of this panel PN include a panel including a liquid crystal and a panel including an organic light-emitting diode.

The printed circuit board PCB is connected to an external system which is not shown, and image data and various control signals from the external system are supplied to the driving circuit DRC through the printed circuit board PCB.

The display portion D of the panel PN is provided with a plurality of gate lines GL, a plurality of data lines DL, and pixels displaying image in accordance with image data from the data lines DL and gate signals from the gate lines GL, wherein the gate lines GL cross the data lines DL.

The non-display portion ND of the panel PN is provided with a plurality of data link lines for transmitting the image data from the driving circuit DRC to the data lines DL, and a plurality of gate link lines for transmitting the gate signals from the driving circuit DRC to the gate lines GL.

The driving circuit DRC of FIG. 1 will be described in more detail.

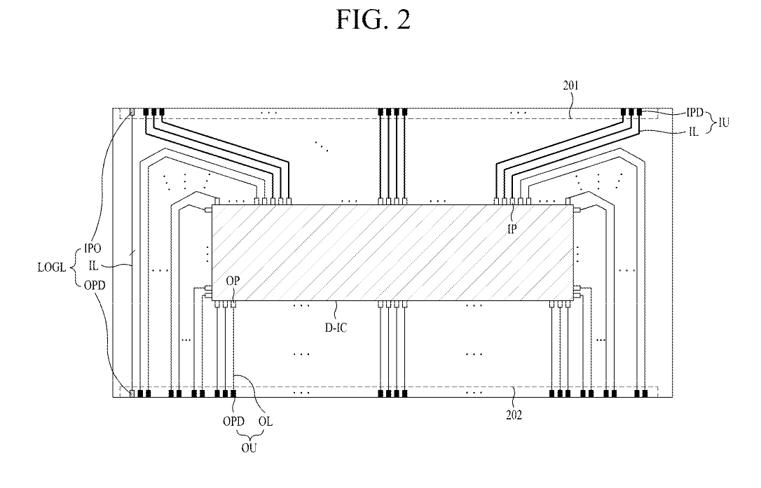

FIG. 2 is a detailed diagram illustrating a driving circuit of FIG. 1.

As shown in FIG. 2, the surface-mounted tape carrier package TCP includes a package area where the driving integrated circuit D-IC is packaged in a chip on film (COF) manner, a plurality of input patterns IU for connecting input pins IP of the driving integrated circuit D-IC to the external system, and a plurality of output patterns OU for connecting output pins OP of the driving integrated circuit D-IC to the panel PN. For discrimination between the input patterns IU and the output patterns OU in FIG. 2, input lines IL included in the input patterns IU are thicker than output lines OL included in the output patterns OU. This only illustrates the difference in thickness for convenience in discrimination. Actually, the input lines IL of the input patterns IU can be set at the same thickness as that of the output lines OL of the output patterns OU.

The input patterns IU are to connect the input pins IP of the driving integrated circuit D-IC to the external system. Each of the input patterns IU includes an input pad IPD formed at an input pad portion 201 located at one end of the surface-mounted tape carrier package TCP, and an input line IL connecting the input pad IPD with the input pin IP.

The output patterns OU are to connect the output pins OP of the driving integrated circuit D-IC to the panel PN, i.e., the data lines DL of the panel PN. Each of the output patterns OU includes an output pad OPD formed at an output pad portion 202 located at the other end of the surface-mounted tape carrier package TCP, and an output line OL connecting the output pad OPD with the output pin OP.

A plurality of line on glass (LOG) type transmission patterns LOGL are formed at the left edge of the surface-mounted tape carrier package TCP. The LOG type transmission patterns LOGL are directly connected to LOG type signal transmission lines formed at the non-display portion ND of the panel PN without passing through the driving integrated circuit D-IC. The LOG type transmission patterns LOGL serve to supply a ground voltage and a driving voltage, which are supplied from the external system through the printed circuit board (PCB), to the panel PN. The LOG type transmission pattern LOGL includes an input pad IPD formed at the input pad portion 201, an output pad OPD formed at the output pad portion 202, and a transmission line IL connecting the input pad IPD with the output pad OPD.

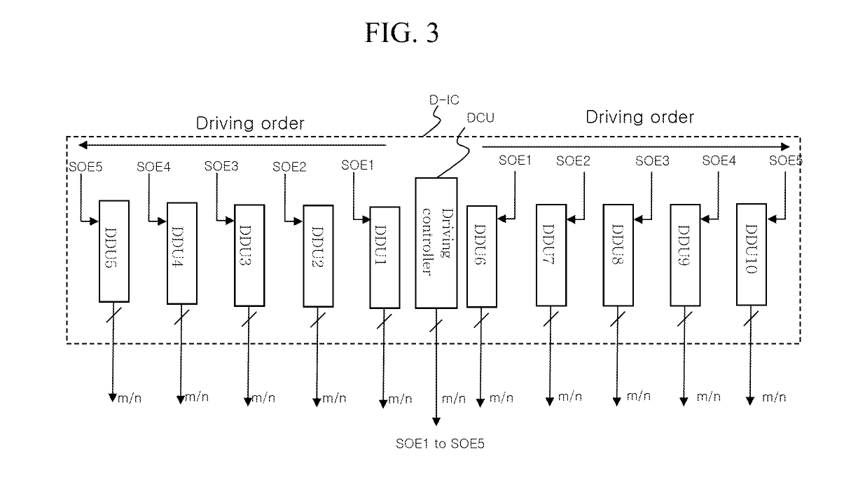

FIG. 3 is a detailed schematic diagram illustrating a driving integrated circuit according to the first embodiment of the present invention.

The driving integrated circuit according to the present invention, as shown in FIG. 3, includes a plurality of data driving unit DDU1 to DDU10 and a driving control unit DCU for controlling the data driving units.

The driving controller DCU sequentially generates a plurality of source output enable signals SOE1 to SOE5 for determining output timing of image data from the data driving units, and directly supplies each of the source output enable signals SOE1 to SOE5 to each of the data driving units DDU1 to DDU10 to drive the data driving unit DDU1 to DDU10 sequentially.

n number of data driving units DDU1 to DDU10 (n is an even number greater than 3) are arranged at both sides of the driving controller DCU based on the driving controller DCU in half. For example, n/2 number of data driving units are arranged at a left side of the driving controller DCU, while the other n/2 number of data driving units are arranged at a right side of the driving controller DCU.

The driving controller DCU sequentially supplies n/2 number of source output enable signals SOE1 to SOE5 to n/2 number of data driving units DDU1 to DDU5 arranged at one side of the driving controller DCU, so that the data driving unit DDU1 located closest to the driving controller DCU to the data driving unit DDU5 located farthest away from the driving controller DCU are sequentially driven. Also, the driving controller DCU sequentially supplies n/2 number of source output enable signals SOE1 to SOE5 to n/2 number of data driving units DDU6 to DDU10 arranged at the other side of the driving controller DCU, so that the data driving unit DDU6 located closest to the driving controller DCU to the data driving unit DDU10 located farthest away from the driving controller DCU are sequentially driven.

For example, it is supposed that first to fifth source output enable signals SOE1 to SOE5 are sequentially output in the order of numbering. In other words, among the first to fifth source output enable signals SOE1 to SOE5, the first source output enable signal SOE1 having the fastest numbering is first output. At this time, the driving controller DCU supplies the first source output enable signal SOE1 to each of the first data driving unit DDU1 and the sixth data driving unit DDU6 at the same time, wherein the first data driving unit DDU1 is located closest to the driving controller DCU among the first to fifth data driving units located at the left side of the driving controller DCU shown in FIG. 3, and the sixth data driving unit DDU6 is located closest to the driving controller DCU among the sixth to tenth data driving units DDU6 to DDU10. Afterwards, the driving controller DCU sequentially outputs the second to fifth source output enable signals SOE2 to SOE5 and supplies the source output enable signals SOE2 to SOE5 to a pair of data driving units at the same time, wherein the data driving units are located at both sides of the driving controller DCU and face each other. Accordingly, the five data driving units DDU1 to DDU5 located at the left side of the driving controller DCU are sequentially driven in the order located innermost. At the same time, the five data driving units DDU6 to DDU10 located at the right side of the driving controller DCU are sequentially driven in the order located innermost.

As described above, in the present invention, the driving controller DCU generates a plurality of source output enable signals SOE1 to SOE5, which are sequentially output, by using an external control signal, and directly supplies each of the source output enable signals to the corresponding data driving unit, whereby deviation between image data of each data driving unit, which is caused by distortion of the source output enable signals, can be prevented from occurring.

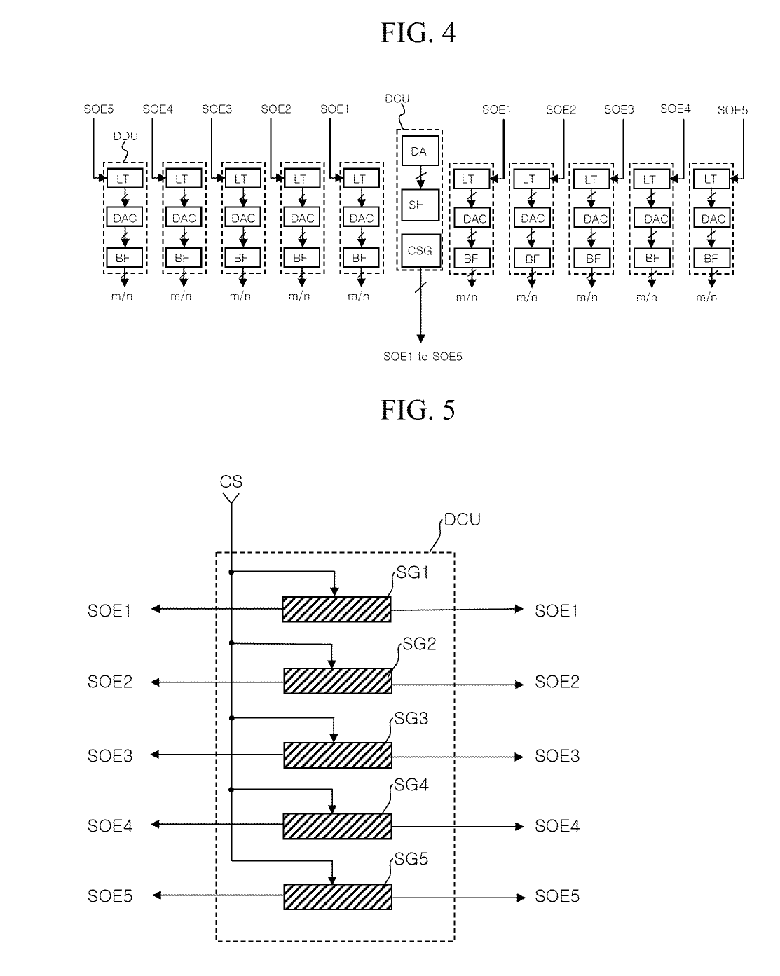

FIG. 4 is a detailed diagram illustrating a driving controller DCU and a data driving unit of FIG. 3.

The driving controller DCU, as shown in FIG. 4, includes a data alignment unit DA, a sample/holding unit SH, and a control signal generator CSG.

The data alignment unit DA realigns image data of the external system and output them.

The sample/holding unit SH sequentially samples and holds the image data from the data alignment unit DA. The sample/holding unit SH divides the sampled m number of image data by m/n and supplies them to n number of data driving units DDU1 to DDU10 at the same time.

The control signal generator CSG receives a control signal from the external system and outputs various timing control signals including the first to fifth source output enable signals SOE1 to SOE5.

Each of the data driving units DDU1 to DDU10 includes a latch unit LT, a digital-to-analog converter DAC and a signal buffer BF.

The latch unit LT of each of the data driving units DDU1 to DDU10 is supplied with m/n number of sampled image data among m number of sampled image data (m=k*n; k is a natural number greater than 3) from the sample/holding unit SH, and outputs m/n number of sampled image data at the same time in response to any one of the first to fifth source output enable signals SOE1 to SOE5. Namely, m number of sampled image data stored in the sample/holding unit SH are supplied to the latch unit LT of each of the data driving units DDU1 to DDU10 at an equivalent ratio. Each latch unit LT outputs the sampled image data supplied thereto at the same time in response to the corresponding source output enable signal from the control signal generator CSG.

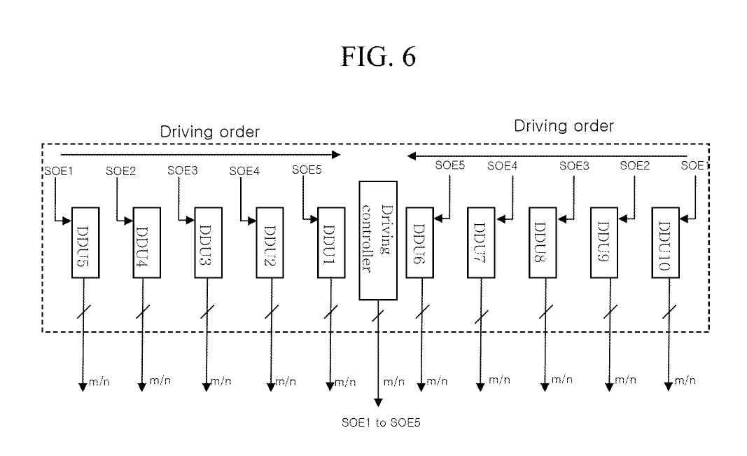

FIG. 5 is a detailed schematic diagram illustrating a driving controller.

The driving controller DCU, as shown in FIG. 5, includes a plurality of signal generators SG1 to SG5. Each of the signal generators SG1 to SG5 is supplied with a control signal from the external system and generates a corresponding source output enable signal. For example, the first signal generator SG1 generates a first source output enable signal SOE1 by using the control signal CS and supplies the first source output enable signal SOE1 to the first and sixth data driving units DDU1 and DDU6 at the same time. The second signal generator SG2 generates a second source output enable signal SOE2 by using the control signal CS and supplies the second source output enable signal SOE2 to the second and seventh data driving units DDU2 and DDU7 at the same time. The third signal generator SG3 generates a third source output enable signal SOE3 by using the control signal CS and supplies third source output enable signal SOE3 to the third and eighth data driving units DDU3 and DDU8 at the same time. The fourth signal generator SG4 generates a fourth source output enable signal SOE4 by using the control signal CS and supplies fourth source output enable signal SOE4 to the fourth and ninth data driving units DDU4 and DDU9 at the same time. Finally, the fifth signal generator SG5 generates a fifth source output enable signal SOE5 by using the control signal CS and supplies fifth source output enable signal SOE5 to the fifth and tenth data driving units DDU5 and DDU10 at the same time.

FIG. 6 is a detailed schematic diagram illustrating a driving integrated circuit according to the second embodiment of the present invention.

The driving integrated circuit according to the second embodiment of the present invention, as shown in FIG. 6, includes a plurality of data driving units DDU1 to DDU10 and a driving controller DCU for controlling the driving of data driving units DDU1 to DDU10. The driving integrated circuit according to the second embodiment of the present invention is almost identical with the driving integrated circuit DRC according to the first embodiment of the present invention and is different from that according to the first embodiment of the present invention in the driving order of the data driving units DDU1 to DDU10. In other words, as shown in FIG. 6, the driving controller DCU sequentially supplies n/2 number of source output enable signals SOE1 to SOE5 to n/2 number of data driving units DDU1 to DDU5 arranged at one side of the driving controller DCU, so that the data driving unit DDU5 located farthest away from the driving controller DCU to the data driving unit DDU1 located closest to the driving controller DCU are sequentially driven. Also, the driving controller DCU sequentially supplies n/2 number of source output enable signals SOE1 to SOE5 to n/2 number of data driving units DDU6 to DDU10 arranged at the other side of the driving controller DCU, so that the data driving unit DDU10 located farthest away from the driving controller DCU to the data driving unit DDU6 located closest to the driving controller DCU are sequentially driven.

For example, it is supposed that the first source output enable signal SOE1 is output to the fifth data driving unit DDU5 and the tenth data driving unit DDU10 at the same time, wherein the fifth data driving unit DDU5 is located farthest away from the driving controller DCU among the first to fifth data driving units DDU1 to DDU5 located at the left side of the driving controller DCU shown in FIG. 6 and the tenth data driving unit DDU10 is located farthest away from the driving controller DCU among the sixth to tenth data driving units DDU6 to DDU10 located at the right side of the driving controller DCU. Afterwards, the driving controller DCU sequentially outputs the second to fifth source output enable signals SOE2 to SOE5 and supplies the source output enable signals SOE2 to SOE5 to a pair of data driving units at the same time, wherein the data driving units are located at both sides of the driving controller DCU and face each other. Accordingly, the five data driving units DDU1 to DDU5 located at the left side of the driving controller DCU are sequentially driven in the order located outermost. At the same time, the five data driving units DDU6 to DDU10 located at the right side of the driving controller DCU are sequentially driven in the order located outermost.

As described above, in the present invention, the driving controller DCU generates a plurality of source output enable signals SOE1 to SOE5, which are sequentially output, by using an external control signal, and directly supplies each of the source output enable signals to the corresponding data driving unit, whereby deviation between image data of each data driving unit, which is caused by distortion of the source output enable signals, can be prevented from occurring.

Meanwhile, the driving integrated circuit D-IC according to the present invention includes functions of a gate driving integrated circuit, a timing controller and a DC-to-DC converter in addition to the aforementioned data driving units DDU. Namely, the driving integrated circuit D-IC performs the functions of the timing controller and the DC-to-DC converter and also performs the function of the gate driving integrated circuit driving the gate lines GL.

The timing controller generates a data control signal and a gate control signal by using horizontal synchronizing signals, vertical synchronizing signals and clock signals, which are supplied from the external system, and supplies them to the plurality of data driving units DDU and the plurality of gate driving integrated circuits. The data control signal includes a dot-clock, a source shift clock, a source enable signal, and a polarity inversion signal. The gate control signal includes a gate start pulse, a gate shift clock, and a gate output enable signal.

The gate driving integrated circuits include a shift register sequentially generating scan pulses in response to a gate start pulse of the gate control signal from the timing controller, and a level shifter for shifting a voltage of the scan pulses to a voltage level suitable for driving of a liquid crystal cell. The gate driving integrated circuits sequentially supply a gate high voltage to the gate lines GL in response to the gate control signal.

The DC-to-DC converter boosts or lowers the power from the system to provide various driving voltages required for the timing controller, the data driving units DDU, and the gate driving integrated circuits and a gamma reference voltage required to generate a gamma voltage. Also, the DC-to-DC converter provides a gate high voltage corresponding to a high voltage of the scan pulses and a gate low voltage corresponding to a low voltage of the scan pulses.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A driving circuit for a display device, comprising:
a plurality of data driving units supplying image data to a display portion of a panel through data link lines formed at a non-display portion of the panel; and
a driving controller sequentially generating a plurality of source output enable signals determining output timing of the image data from the data driving units, and directly supplying each of the source output enable signals to each of the data driving units to sequentially drive the data driving units.

2. The driving circuit for a display device of claim 1, wherein n number of data driving units (n is an even number greater than 3) are arranged at both sides of the driving controller based on the driving controller in half as much as n/2, and
the driving controller sequentially supplies n/2 number of source output enable signals to n/2 number of data driving units arranged at one side of the driving controller, so that the data driving unit located closest to the driving controller to the data driving unit located farthest away from the driving controller are sequentially driven, and also sequentially supplies n/2 number of another source output enable signals to n/2 number of data driving units arranged at the other side of the driving controller, so that the data driving unit located closest to the driving controller to the data driving unit located farthest away from the driving controller are sequentially driven.

3. The driving circuit for a display device of claim 2, wherein the data driving controller includes a data alignment unit realigning image data from an external system and outputting them;
a sample/holding unit sequentially sampling and holding the image data from the data alignment unit; and
a control signal generator receiving a control signal from the external system and outputting various timing control signals including the source output enable signals.

4. The driving circuit for a display device of claim 3, wherein each data driving unit includes
a latch unit supplied with m/n number of sampled image data among m number of sampled image data (m=k*n; k is a natural number greater than 3) from the sample/holding unit, and outputting m/n number of sampled image data at the same time in response to the source output enable signals from the control signal generator;
a digital-to-analog converter converting the m/n number of sampled image data from the latch unit to analog signals; and
a signal buffer buffering the image data from the digital-to-analog converter.

5. The driving circuit for a display device of claim 3, wherein the control signal generator includes a plurality of signal generators generating n/2 number of source output enable signals in response to a control signal from the external system.

6. The driving circuit for a display device of claim 1, wherein n number of data driving units (n is an even number greater than 3) are arranged at both sides of the driving controller based on the driving controller in half as much as n/2, and
the driving controller sequentially supplies n/2 number of source output enable signals to n/2 number of data driving units arranged at one side of the driving controller, so that the data driving unit located closest to the driving controller to the data driving unit located farthest away from the driving controller are sequentially driven, and also sequentially supplies n/2 number of another source output enable signals to n/2 number of data driving units arranged at the other side of the driving controller, so that the data driving unit located farthest away from the driving controller to the data driving unit located closest to the driving controller are sequentially driven.

7. A method for driving a driving circuit for a display device including a plurality of data driving units supplying image data to a display portion of a panel through data link lines formed at a non-display portion of the panel, the method comprising:
sequentially generating a plurality of source output enable signals determining output timing of the image data from the data driving units; and
directly supplying each of the source output enable signals to each of the data driving units to sequentially drive the data driving units.

8. The method of claim 7, wherein the source output enable signals are output from a driving controller,
n number of data driving units (n is an even number greater than 3) are arranged at both sides of the driving controller based on the driving controller in half as much as n/2, and
the driving controller sequentially supplies n/2 number of source output enable signals to n/2 number of data driving units arranged at one side of the driving controller, so that the data driving unit located closest to the driving controller to the data driving unit located farthest away from the driving controller are sequentially driven, and also sequentially supplies n/2 number of another source output enable signals to n/2 number of data driving units arranged at the other side of the driving controller, so that the data driving unit located closest to the driving controller to the data driving unit located farthest away from the driving controller are sequentially driven.

9. The method of claim 7, wherein the source output enable signals are output from a driving controller,
n number of data driving units (n is an even number greater than 3) are arranged at both sides of the driving controller based on the driving controller in half as much as n/2, and
the driving controller sequentially supplies n/2 number of source output enable signals to n/2 number of data driving units arranged at one side of the driving controller, so that the data driving unit located closest to the driving controller to the data driving unit located farthest away from the driving controller are sequentially driven, and also sequentially supplies n/2 number of another source output enable signals to n/2 number of data driving units arranged at the other side of the driving controller, so that the data driving unit located farthest away from the driving controller to the data driving unit located closest to the driving controller are sequentially driven.
